(19) United States
(12) Patent Application Publication
(10) Pub. No.: US 2020/0062387 A1
(43) Pub. Date: Feb. 27, 2020

(54) UNMANNED AERIAL VEHICLE BOOSTERS

(71) Applicant: Hewlett Packard Enterprise Development LP, Houston, TX (US)

(72) Inventor: Seth Pickett, Fort Collins, CO (US)

(21) Appl. No.: 16/108,495

(22) Filed: Aug. 22, 2018

(51) Int. Cl. B64C 39/02

(52) U.S. Cl. CPC B64C 39/024; B64C 2201/024; B64C 2201/042; B64C 2201/082; B64C 2201/127; B64C 2201/141; B64C 2201/146; B64C 2201/066

(57) ABSTRACT

In some examples, an unmanned aerial vehicle (UAV) booster includes a housing; a propulsion mechanism coupled to the housing to move the UAV booster to a threshold altitude; and an attachment mechanism coupled to the housing to couple to a UAV and permit the UAV to be selectively decoupled from the attachment mechanism when the UAV booster is at the threshold altitude.

### BACKGROUND

An unmanned aerial vehicle (UAV) (i.e., a drone) is an aircraft that operates without a human pilot aboard the UAV. A UAV may be included in an unmanned aircraft system (UAS). A UAS may include a UAV, a controller such as a ground-based controller, and a system of communications between the UAV and the controller. A UAV may operate under remote control by a human operator or autonomously under control of a computer such as a computer onboard the UAV. The UAV can include an imaging system including a camera to perform surveillance. For instance, the UAV can perform surveillance while airborne.

### BRIEF DESCRIPTION OF THE DRAWINGS

FIG. 1 is an example of an unmanned aerial vehicle (UAV) booster consistent with the present disclosure.

FIG. 2A is an example of an attachment mechanism in a closed position consistent with the present disclosure.

FIG. 2B is another example of an attachment mechanism in a closed position consistent with the present disclosure.

FIG. 2C is another example of an attachment mechanism in an open position consistent with the present disclosure.

FIG. 3 is an example of a system including an example of a UAV booster consistent with the present disclosure.

FIG. 4 is an example of a controller consistent with the present disclosure.

FIG. 5 is an example of a non-transitory machine readable medium consistent with the present disclosure.

FIG. 6 illustrates an example of a method consistent with the disclosure.

### DETAILED DESCRIPTION

Objects and/or areas, such as factory complexes, building complexes, buildings, and industrial complexes, can be surveyed using video or other surveillance systems. For instance, some approaches may employ video surveillance systems involve static cameras. However, such cameras may be limited to surveillance of static areas in range of the static camera as the camera may not be readily repositioned at a different geographic location. Other approaches may employ mobile cameras such as a camera included in an unmanned aerial vehicle (UAV).

However, a UAV may include a battery with a finite amount of power. Operation of the UAV such operation of a camera and/or operation of rotors to cause the UAV to fly may draw power from the battery. For instance, causing a UAV to fly from a ground level to an operational altitude may use a portion of the battery power of the UAV. Consequently, the UAV may have a limited amount of time the UAV can perform various operations such as surveillance while the UAV is flying. For instance, the UAV may cease surveillance while flying to instead move to a base (i.e., a docking station) and/or recharge a battery at the base.

As such, the disclosure is directed to UAV boosters. For instance, a UAV booster can include a propulsion mechanism (e.g., a rotor) to move the UAV booster and a UAV coupled via an attachment mechanism to the UAV booster to a threshold altitude (i.e., an operational altitude of the UAV) and selectively decouple the UAV from the UAV booster at the threshold altitude, as detailed herein. That is, as used herein a “UAV booster” refers to a device including a propulsion mechanism to move a UAV booster and a UAV, when present, coupled via an attachment mechanism to the UAV booster to a threshold altitude. As such, the UAV can be positioned at a threshold altitude and yet have an extended operation duration, in contrast to approaches using power from the UAV itself to move the UAV to a threshold altitude. Moreover, an attachment mechanism of the UAV booster can selectively decouple a UAV at a threshold altitude. Notably, such selective decoupling by the attachment mechanism can avoid/mitigate a potential for an unintentional decoupling of a UAV and/or that of a UAV freefalling from the UAV booster. For instance, if a UAV does not decouple from the UAV booster at the threshold altitude, then the UAV can remain coupled to the UAV booster in a secure manner (e.g., by actuating a movable member from an open position to a closed position) and the UAV can be safely returned along with the UAV booster to a base of the UAV booster. As used herein, being “coupled” refers to being in physical contact with another element such as a UAV being in direct physical contact with a UAV booster. As used herein, being “decoupled” refers to an absence of physical contact with another element such as UAV that is spaced a distance away from a UAV booster and not in direct physical contact or otherwise in physical contact with a UAV booster.

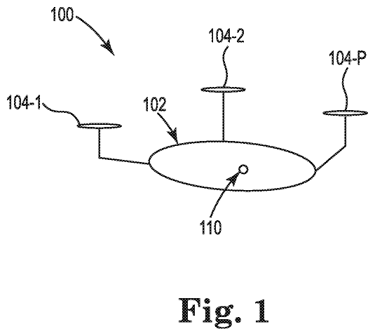

FIG. 1 is an example of a UAV booster 100 consistent with the present disclosure. As illustrated in FIG. 1, the UAV booster 100 can include a housing 102, a propulsion mechanism 104 such as propulsion mechanisms 104-1, 104-2, . . . , 104-P (collectively referred to as propulsion mechanism 104), and an attachment mechanism 110.

The housing 102 can form an exterior surface of the UAV booster 102. In various examples, the housing 102 can define a cavity of UAV booster 102, as described herein. For instance, components such as the attachment mechanism 110 can be disposed in the cavity and/or otherwise coupled to the housing 102. As used herein, “disposed” means a location at which something is physically positioned. In various examples, the housing 102 and/or cavity can include components such as a display, battery, input/output device, among other types of components. The housing 102 can be formed of fabric, metal, and/or plastic, among other suitable materials to promote aspects of UAV boosters, as described herein.

As used herein, the propulsion mechanism 104 refers to a device or component that is to drive or push a UAV booster to a threshold altitude. The propulsion mechanism 104 can be a mechanical propulsion mechanism, a chemical propulsion mechanism, a solar propulsion mechanism, and/or an electromagnetic propulsion mechanism. Examples of mechanical propulsion mechanisms include rotors and/or an airfoils (i.e., wings), among other types of mechanical propulsion mechanisms. For instance, as illustrated in FIG. 1 in some examples each of the propulsion mechanisms 104 can be a mechanical propulsion mechanism such as a rotor or other mechanical propulsion mechanism. While FIG. 1 illustrates a total of three propulsion mechanisms, it is understood that the total number of propulsion mechanisms can be increased or decreased from the number illustrated in FIG. 1.

As used herein, the attachment mechanism 110 refers to a device coupled to a housing 102 of a UAV booster to permit a UAV to be selectively decoupled from the UAV booster when the UAV booster is at a threshold altitude. As illustrated in FIG. 1, the attachment mechanism 110 can be directly coupled to the housing 102. As used herein, “directly coupled” refers to being coupled to an element without an intervening element. However, the disclosure is not so limited.

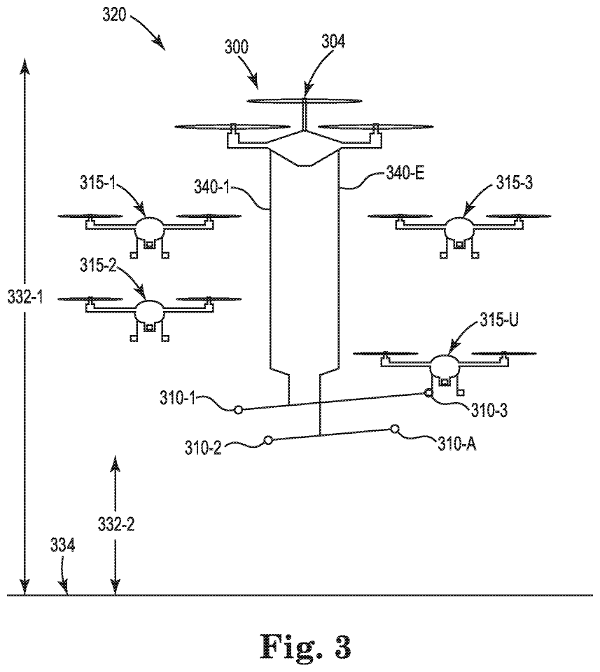

For instance, as detailed herein with respect to FIG. 3 in some examples the attachment mechanism can be indirectly coupled to the housing 102. As used herein, “indirectly coupled” refers to having at least one intervening element between two elements that are coupled together. Examples of intervening elements may include mechanical fasteners (e.g., screws, bolts), additional layers of materials (adhesives, paint, and/or other coatings), and/or physical components such as an arm as detailed herein. Moreover, while illustrated in FIG. 1 as being on an external surface of the housing 102, in some examples the attachment mechanism can be formed of and/or included in a cavity or other internal surfaces defined by the housing 102.

As used herein, a threshold altitude refers to a height of a UAV booster and/or a UAV above a ground level as detailed herein and illustrated with respect to FIG. 3. For instance, a threshold altitude can be a height in a range of from 4 feet to 400 feet, an altitude in a range of from 4 feet to 2,000 feet, an altitude in a range of from 4 feet to 4,000 feet, an altitude in a range of from 4 feet to 10,000 feet, among other possibilities including all individual ranges and values included within the range of from 4 feet to 10,000 feet. For instance, the threshold altitude can be an altitude in a range having a lower bound of 4 feet, 25 feet, 40 feet, 100 feet, 150 feet, 250 feet, or 400 feet to an upper bound of 25 feet, 100 feet, 175 feet, 250 feet, 350 feet, 400 feet, 1,000 feet, 2,000 feet, 3,000 feet, 4,000 feet, or 10,0000 feet. Similarly, the threshold altitude can be a height of 25 feet, 100 feet, 175 feet, 250 feet, 350 feet, 400 feet, 1,000 feet, 2,000 feet, 3,000 feet, 4,000 feet, 4,000 feet, or 10,000 feet, among other possible values.

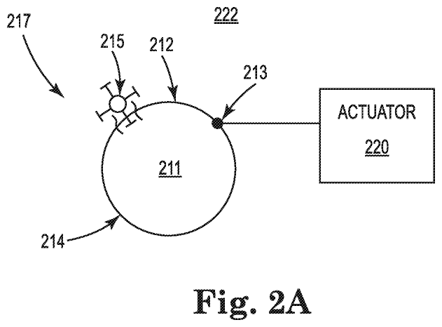

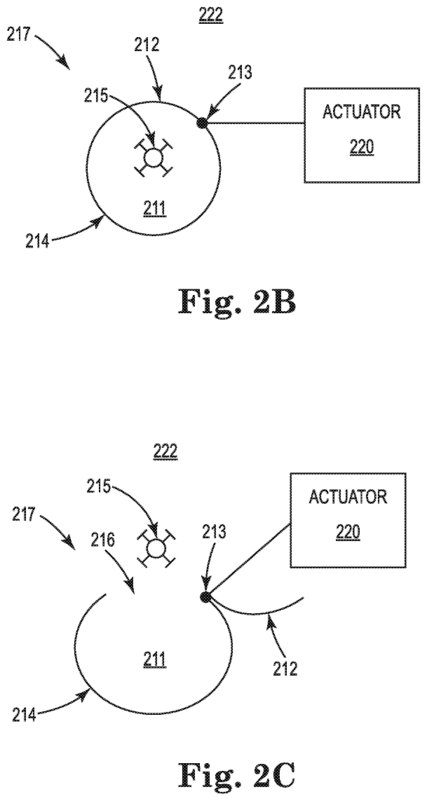

FIG. 2A is an example of an attachment mechanism 217 in a closed position consistent with the present disclosure. The attachment mechanism 217 can be formed of the same or a different material as a housing (e.g., housing 102). For instance, the attachment mechanism 217 can be formed of fabric, metal, and/or plastic, among other suitable material to promote aspects of UAV boosters, as described herein.

As illustrated in FIG. 2A, the attachment mechanism 217 can include a movable member 212 coupled via a pivot point 213 or other type of attachment point to a continuous portion 214 to permit movement of the movable member 212 relative to the continuous portion 214. That is, as used herein, a “movable member” refers to a length of material formed of fabric, metal, and/or plastic, among other suitable material that can be actuated, by an actuator or otherwise, between a closed position and an open position.

For instance, as illustrated in FIG. 2A, when in a closed position the movable member 212 and the continuous portion 214 can together mechanically contact with and retain a portion of a UAV 215 between the movable member 212 and the continuous member 214 or otherwise retain a portion or all of a UAV in the cavity 211. Stated differently, a UAV coupled via the attachment mechanism 217 to a housing can be partially or entirely retained in the cavity 211 such that some or none of the UAV can be present in an environment 222 surrounding an attachment mechanism 217 of a UAV booster.

The movable member 212 can be coupled to an actuator 220. The actuator 220 can include an actuator with mechanical energy to move the movable member 212 between a closed position and an open position. For example, the actuator 220 can include a spring loaded mechanism, a rotary mechanism, a slidable mechanism, and/or other type of mechanisms to provide a force to move the movable member 212 between the closed position (e.g., as illustrated in FIGS. 2A and 2B) and the open position (e.g., as illustrated in FIG. 2C).

The movable member 212 can move about the pivot point 213. While described as a pivot point 213, it is understood that the pivot point 213 can represent a point about and/or along which the movable member 212 can translate relative to the continuous portion 214. For instance, while the attachment mechanism 217 is illustrated as including a cavity, in some example the attachment mechanism 217 can be without a cavity. For example, the movable member 212 and the continuous member 214 can move relative to each other to selectively couple and/or decouple a portion of a UAV between the movable member 212 but can do so in the absence of a cavity 211.

FIG. 2B is another example of attachment mechanism 217 in a closed position consistent with the present disclosure. When in the closed position the movable member 212 and the continuous portion 214 can together form the cavity 211 and the UAV 215 can be disposed entirely within the cavity 211. That is, is some examples the cavity 211 can be sized with a diameter large enough to enclose a UAV and/or a plurality of UAVs. For instance, as illustrated in FIG. 2 the cavity can be sized to entirely enclose the UAV 215 in a volume of the cavity 211. In such examples, the UAV 215 can be coupled via an additional attachment mechanism (not illustrated) such as those described in FIG. 2A or otherwise to a surface in the cavity 211 to permit selective decoupling of the UAV from the surface of the cavity 211. For instance, when the movable member 212 is in an open position the UAV 215 can be selectively decoupled from the cavity 211. In some examples, when a plurality of UAVs are disposed within the cavity 211, a subset comprising two or more UAVs of the plurality of UAVs can be selectively decoupled from the cavity 211 at the same time when the movable member 212 is in an open position.

FIG. 2C is an example of an attachment mechanism in an open position consistent with the present disclosure. That is, whereas cavity 211 is physically separated from the environment 222 surrounding the UAV booster when in the closed position in FIGS. 2A and 2B, the UVA 215 can move through the opening 216 from being partially (or wholly) disposed within the cavity 211 to the environment 222, as illustrated in FIG. 2C. That is, when in the open position as illustrated in FIG. 2C, the movable member 212 and the continuous member 214 can together expose the opening 216 between the cavity 211 the environment 222 surrounding a UAV booster and the attachment mechanism 217.

In various examples, the movable member 212 can actuate from a closed position (as illustrated in FIGS. 2A and/or 2B) to an open position (as illustrated in FIG. 2C) when the UAV booster is at the threshold altitude, as described herein. For instance, the actuator 220 can actuate the movable member 212 to create the opening 216 in the attachment mechanism 217 and permit the UAV 215, when present, to be selectively decoupled via the opening 216 from the attachment mechanism 217.

In such examples, the attachment mechanism 217 can include a continuous portion 214 defining the opening 216, as illustrated in FIG. 2C. The continuous portion 214 can extend along a lower surface and side surfaces of the attachment mechanism 217 (forming a substantially U-shaped continuous portion) to retain the UAV in the attachment mechanism 217, as illustrated in FIGS. 2A, 2B. A substantially U-shaped portion refers to a structure having a U-shape or other substantially similar shape so as to achieve the result of permitting selective decoupling of a UAV from the UAV booster. For instance, in such examples a UAV can fly out of an opening in the “top” of the U-shaped portion under its own power when the UAV booster is at a threshold altitude to avoid unintentional release of the UAV from the UAV booster. However, a shape of the continuous portion, a location, and/or a total number of the continuous portion and/or the opening can be varied. While the UAV can fly out of an opening, the UAV may also be decoupled and passed through the opening by actuation of the movable member 212 such as the movable member selective imparting a force by push, pull, rotate, etc. on a given UAV to cause the UAV to selectively decouple from the UAV booster.

FIG. 3 is an example of a system 320 including a UAV booster 300 consistent with the present disclosure. As illustrated in FIG. 3, the system 320 can include a UAV booster 300 including a propulsion mechanism 304 and an attachment mechanism such as a plurality of attachment mechanisms 310-1, 310-2, 310-3, . . . , 310-A (collectively referred to herein as attachment mechanism 310). The propulsion mechanism 304 can be analogous or similar to propulsion mechanism 104 as described with respect to FIG. 1.

The attachment mechanism 310 can be analogous or similar to attachment mechanism 217 as illustrated in FIGS. 2A and 2B. In some examples, each attachment mechanism of the plurality of attachment mechanisms 310 is to couple to a respective UAV of a plurality of UAVs. That is, as illustrated in FIG. 3 an attachment mechanism can be in a 1:1 relationship with a UAV. For instance, an attachment mechanism can include a plurality of movable members to permit selectively decoupling a plurality of UAVs. For instance, an individual attachment mechanism can include two movable members to permit the selective decoupling of two UAVs. In such examples, each attachment mechanism of the plurality of attachment mechanisms can include a respective movable member. Each respective movable member can actuate from a closed position to an open position, for instance, when the UAV booster reaches a threshold altitude, to expose an opening and permit the UAV to be decoupled, via the exposed opening, from the attachment mechanism. However, relationships other than a 1:1 relationship between a movable member and a UAV are possible. For example, a plurality of UAVs can be included in a cavity forming an individual attachment mechanism, in some examples.

As illustrated in FIG. 3, in some examples, the attachment mechanism 310 can be spaced a distance away from the housing by an arm such as a first arm 340-1 and a second arm 340-E (collectively referred to herein as arm 340) extending a distance away from the housing of the UAV booster 300. That is, the first arm 340-1 and the second arm 340-E can extend a distance away from a housing of the UAV booster 300 in substantially the same direction, as illustrated in FIG. 3, or can extend in different directions. In any case, having the attachment mechanism spaced a distance away from the UAV booster can promote selective decoupling of the UAV, for instance, by reducing a likelihood of physical contact between the UAV booster 300 and the UAV 315 as the UAV is selectively decoupled from the attachment mechanism 310.

As illustrated in FIG. 3, the system 320 can include a UAV such as a plurality of UAVs 315-1, 315-2, 315-3, . . . , 315-U (collectively referred to herein as UAV 315). As used herein, a “UAV” refers to an aircraft that does not have a human pilot on board, and whose flight is controlled autonomously by an on-board computing system and/or by a human or computer via remote control. A UAV can navigate (e.g., autonomously using geographic information system (GIS) coordinates) to a location such as vantage point and capture images or other information of the location.

As used herein, “a vantage point” refers to a geographic location. The geographic location can be an absolute geographic location defined by a longitude and a latitude, among other possibilities. Examples of vantage points include an aerial location (i.e., a location of a UAV while a UAV is flying) and/or surface location when the UAV is grounded (i.e., not in-flight). As used herein, “moving towards” or “move to” a location such as a vantage point refers to changing a geographic location of a UAV to a different geographic location that is closer to or located at the different location. For instance, a UAV can follow a programmed flight path and/or respond to a user input to move towards a vantage point and/or move to (return to) a base.

The UAV 315 can include a camera, microphone, and/or other equipment to capture information. The captured images and/or other information can be transmitted, via a network, to a remotely located computing device in a wired and/or wireless manner. For instance, a UAV can include a processing resource, memory, and/or input/output interfaces, including wired network interfaces such as institute of electrical and electronics engineers (IEEE) 802.3 Ethernet interfaces, as well as wireless network interfaces such as IEEE 802.11 Wi-Fi interfaces, although examples of the disclosure are not limited to such interfaces.

A UAV can include a memory resource, including read-write memory, and a hierarchy of persistent memory such as read-only memory (ROM), electrically programmable read-only memory (EPROM), and/or Flash memory. The network can be a wireless network, for example, a wireless local area network (WLAN). As used herein, WLAN can, for example, refer to a communications network that links two or more devices using some wireless distribution method (for example, spread-spectrum or orthogonal frequency-division multiplexing radio), and usually providing a connection through an access point (AP) to the Internet; and thus, providing users with the mobility to move around within a local coverage area and still stay connected to the network.

As mentioned, the UAV 315 can selectively decouple from the UAV booster 300. For instance, as illustrated in FIG. 3 a UAV such as UAV 315-U can be coupled to an attachment point such as attachment point 310-3. The UAV can be selectively decoupled from a UAV booster, as detailed herein. For instance, UAV 315-1, UAV 315-2, and UAV 315-3 as illustrated in FIG. 3 have been decoupled from attachment mechanism. They may be decoupled from the UAV booster together at the same time or sequentially. Responsive to being selectively decoupled, the decoupled UAV can operate under its own power, for instance to fly under its own power. However, in some examples, a UAV can operate under its own power prior to being selectively decoupled to ensure the UAV continues to operate under its own power (e.g., fly) responsive to being selectively decoupled from the UAV booster.

In some examples, a first UAV (e.g., 315-3) of the plurality of UAVs is to selectively decouple from the UAV booster at first threshold altitude 332-1 (e.g., 500 meters) above a ground level 334, while a second UAV (e.g., 315-U) of the plurality of UAVs is to selectively decouple from the UAV booster at a second threshold altitude 333-2 (e.g., 100 meters) above the ground level 334. That is, a UAV such as UAV 315-3 can be decoupled from the UAV booster while another UAV such as UAV 315-U can remain coupled to the UAV booster as illustrated in FIG. 3. In this manner, individual UAVs of the plurality of UAVs can be selectively decoupled at different attitudes (different threshold altitudes). Though in some examples each UAV of a plurality of UAVs can be selectively decoupled from the UAV booster at substantially (+/−10 percent) the same altitude.

A UVA can be decoupled from the UAV booster while the UAV booster is moving (relative to a ground level) laterally, vertically, or both. However, in some examples a UAV can be decoupled from the UAV booster while the UAV booster is substantially stationary (i.e., hovering) relative to the ground level. In some examples, the UAV booster can turn its arm 340 (and or itself including both the housing and the arms) to a particular direction prior to selectively decoupling a particular UAV at a particular altitude.

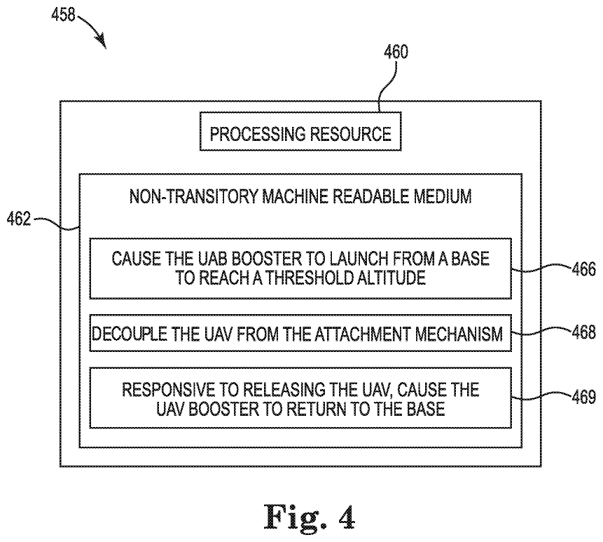

FIG. 4 is an example of a controller 458 consistent with the present disclosure. As described herein, the controller 458 can perform a function related to a UAV booster. Although the following descriptions refer to an individual processing resource and an individual machine-readable storage medium, the descriptions can also apply to a system with multiple processing resources and multiple machine-readable storage mediums. In such examples, the controller 458 can be distributed across multiple machine-readable storage mediums and the controller 458 can be distributed across multiple processing resources. Put another way, the instructions executed by the controller 458 can be stored across multiple machine-readable storage mediums and executed across multiple processing resources, such as in a distributed or virtual computing environment.

As illustrated in FIG. 4, the controller 458 can comprise a processing resource 460, and a memory resource 462 storing machine-readable instructions 466, 468, 469 to cause the processing resource 460 to perform an operation relating to a UAV booster. As used herein, “cause” or “causing” refers to directly causing an action (e.g., asserting/de-asserting a signal sent from a remotely located computing device to a UAV booster and/or a UAV) or performing an action such as sending instructions to another component to cause the action. The remotely located computing device can include a database or other memory resource, a processing resource, a user interface or other input/output devices to permit interaction with a user, central controller for control of UAVs and/or UAV boosters, and/or other equipment to promote aspects of UAV boosters. For instance, using the processing resource 460 and the memory resource 462, the controller 458 can decouple a UAV from an attachment mechanism of a UAV booster at the threshold altitude, among other functions.

Processing resource 460 can be a central processing unit (CPU), microprocessor, and/or other hardware device suitable for retrieval and execution of instructions stored in memory resource 462. Memory resource 462 can be a machine-readable storage medium can be any electronic, magnetic, optical, or other physical storage device that stores executable instructions. Thus, machine-readable storage medium can be, for example, Random Access Memory (RAM), an Electrically-Erasable Programmable Read-Only Memory (EEPROM), a storage drive, an optical disc, and the like. The executable instructions can be “installed” on a UAV booster and/or a UAV. Machine-readable storage medium can be a portable, external or remote storage medium, for example, that allows the UAV booster and/or the UAV (or a different device) to download the instructions from the portable/external/remote storage medium. In this situation, the executable instructions can be part of an “installation package”. As described herein, machine-readable storage medium can be encoded with executable instructions related to UAV boosters.

While FIG. 4 describes instructions 466, 468, 469 with respect to the controller 458, some or all of the instructions 466, 468, 469 can be stored and/or executed in a distributed computing environment such as in a cloud infrastructure that can manage or otherwise interact with UAVs and/or UAV boosters.

The controller 458 can include instructions 466 stored in the memory resource 462 and executable by the processing resource 460 to cause the UAV booster to launch from a base to a threshold altitude. For instance, the UAV booster may launch at a predetermined time, responsive to a user input (e.g., remotely located computing device), among other possibilities. For example, controller 458 can include instructions 466 stored in the memory resource 462 and executable by the processing resource 460 to cause a UAV booster to launch by actuation or other operation of a propulsion mechanism such as those propulsion mechanisms described herein. The controller 458 can include instructions 468 stored in the memory resource 462 and executable by the processing resource 460 to decouple the UAV from the attachment mechanism of the UAV booster at the threshold altitude, as described herein.

The controller 458 can include instructions 469 stored in the memory resource 462 and executable by the processing resource 460 to, responsive to releasing the UAV, cause the UAV booster to return to the base. A base can refer to a docking station. A base such as a docking station can include a power source (to recharge a UAV at the base) and/or other equipment. The power source can refer to any wired or wireless form of power transmission. For instance, in some examples, the power source can include an inductive power source to wireless transfer power to a UAV.

In some examples, the UAV booster can return to the base responsive to selective decoupling of a UAV, reaching a threshold altitude, and/or the UAV booster reaching a base battery level (i.e., a low battery state). For instance, in some example, the instructions 469 can include instructions for the UAV booster to return to base responsive to selectively decoupling each UAV of a plurality of UAVs coupled to the UAV booster. However, in some example, the UAV booster can return to the base responsive to reaching a threshold altitude and/or maintaining a position at a threshold altitude for a period of time (e.g., 10 minutes). As such, should a UAV cease to decouple from the UAV booster the UAV booster can return along with the UAV to a base responsive to elapsing of the predetermined period of time, among other possibilities.

As used herein, the base battery level (i.e., a “low” battery level) refers to a predetermined amount or percentage remaining (e.g., 10%) of a total battery capacity (e.g., e.g., 100%) of a UAV booster that is not charging. The base battery level can be determined while a UAV booster is in flight (not charging). The base battery level can be a numerical value or percentage from 90% to 1% of a total battery capacity of a UAV booster. In this manner, the UAV booster can return to a base (i.e., a docking station) to recharge the battery of the UAV booster reaches a zero or other non-operational battery level.

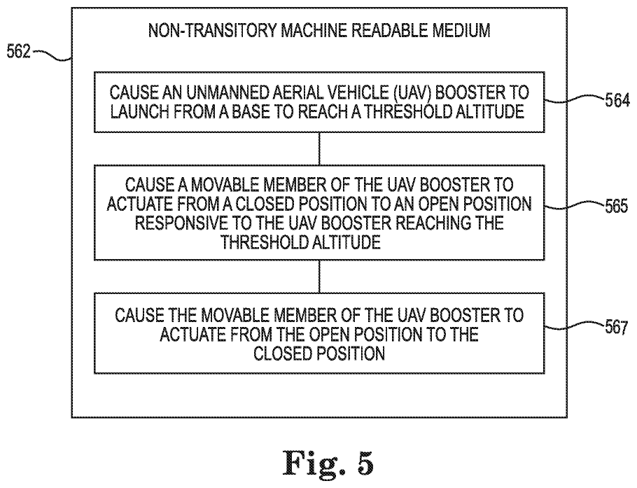

FIG. 5 is an example of a non-transitory machine readable medium 562 consistent with the present disclosure. The machine readable storage medium 562 can be analogous to or similar to non-transitory machine readable medium 462. For instance, the machine readable storage medium 562 can include instructions that are executable by a processing resource such as those described herein to perform functions related to UAV boosters.

In various examples, the machine readable storage medium 562 can include instructions 564, when executed by a processing resource, that can cause a UAV booster to launch from a base to reach a threshold altitude, as described herein.

In various examples, the machine readable storage medium 562 can include instructions 566, when executed by a processing resource, that can cause a movable member of the UAV booster to actuate from a closed position to an open position responsive to the UAV booster reaching the threshold altitude, as described herein.

In various examples, the machine readable storage medium 562 can include instructions 568, when executed by a processing resource, cause the movable member of the UAV booster to actuate from the open position to the closed position, as described herein. For example, the movable member of the UAV booster may actuate from the open position to the closed position subsequent to selectively decoupling a UAV at the threshold altitude.

In some examples, the machine readable storage medium 562 can include instructions (not shown), when executed by a processing resource, cause the UAV booster to substantially at the threshold altitude (e.g., within +/−10% of a threshold altitude) for a predetermined period of time such as a given amount of time such as seconds, minutes, and/or hours. The UAV booster can proceed along a designated flight path at the given altitude and/or in some examples can be maintained at a static geographic location at the threshold altitude for the predetermined period of time.

In some examples, the instructions can further include instructions that responsive to the predetermined period of time elapsing, can cause the UAV booster to move to a different altitude. For instance, the UAV booster can move to a higher or lower altitude and/or return to a base. That is, in some examples the instructions can include instructions to cause the UAV booster to move to a higher or lower altitude, and selectively decouple a UAV from the UAV booster at the higher or lower altitude. In this manner, respective UAVs of a plurality of UAVs coupled to the UAV booster can be decoupled at different altitudes, in some examples.

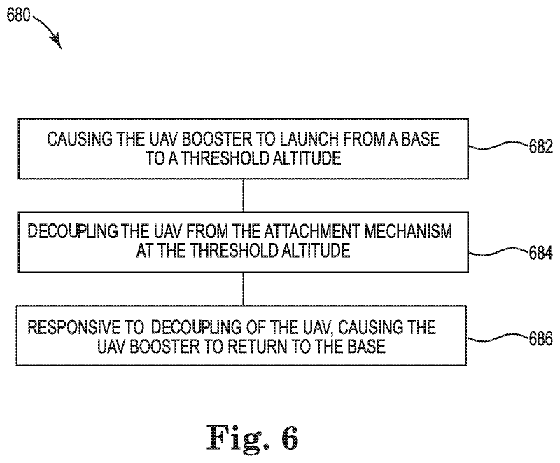

FIG. 6 illustrates an example of a method 680 consistent with the disclosure. At 682, the method 680 can include causing the UAV booster to launch from a base to a threshold altitude, as described herein. At 684, the method 680 can include decoupling the UAV from the attachment mechanism at the threshold altitude, as described herein. For instance, a movable member can be actuated from a closed position to an open position to permit a selected UAV to be decoupled from the UAV booster. At 686, the method 680 can include responsive to decoupling of the selected UAV at the threshold altitude, cause the UAV booster to return to the base, as described herein.

In the foregoing detailed description of the disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the disclosure.

The figures herein follow a numbering convention in which the first digit corresponds to the drawing figure number and the remaining digits identify an element or component in the drawing. Similar elements or components between different figures can be identified by the use of similar digits. For example, 100 can reference element “00” in FIG. 1, and a similar element can be referenced as 300 in FIG. 3. Elements shown in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. Further, as used herein, “a plurality of” an element and/or feature can refer to more than one of such elements and/or features.

What is claimed:

1. An unmanned aerial vehicle (UAV) booster comprising:
a housing;
a propulsion mechanism coupled to the housing to move the UAV booster to a threshold altitude; and
an attachment mechanism coupled to the housing to:
couple to a UAV; and
permit the UAV to be selectively decoupled from the attachment mechanism when the UAV booster is at the threshold altitude.

2. The UAV booster of claim 1, wherein attachment mechanism includes a movable member, wherein the movable member is to actuate from a closed position to an open position when the UAV booster is at the threshold altitude to create an opening in the attachment mechanism and permit the UAV, when present, to be selectively decoupled via the opening from the attachment mechanism.

3. The UAV booster of claim 2, wherein the attachment mechanism includes a continuous portion defining the opening, wherein the continuous portion extends along a lower surface and side surfaces of the attachment mechanism to form a U-shaped continuous portion.

4. The UAV booster of claim 3, wherein the movable member is to actuate from the open position to the closed position when the UAV booster moves from the threshold altitude to retain the UAV in the attachment mechanism until the UAV booster returns to the base, responsive to the UAV remaining coupled to the attachment mechanism.

5. The UAV booster of claim 1, wherein the attachment mechanism is directly coupled to the housing.

6. The UAV booster of claim 1, further including an arm to space the attachment mechanism a distance away from the housing.

7. The UAV booster of claim 1, wherein the movable member and the continuous member together define a cavity of the UAV booster.

8. The UAV booster of claim 7, wherein the cavity is sized to enclose the UAV in a volume of the cavity of the UAV booster.

9. The UAV booster of claim 1, including an actuator coupled to the movable member, wherein the actuator is to actuate the movable member from a closed position to an open position at the threshold altitude.

10. The UAV booster of claim 9, wherein the actuator further is to actuate the movable member from the open position to a closed position responsive to the UAV booster moving from the threshold altitude.

11. The UAV booster of claim 1, wherein the propulsion mechanism includes a rotor.

12. A system comprising:
an unmanned aerial vehicle (UAV) booster including:
a housing;
a propulsion mechanism coupled to the housing; and
an attachment mechanism coupled to the housing;
a UAV coupled via the attachment mechanism to the housing; and
a controller including a processing resource and a non-transitory machine readable medium including instructions executable by the processing resource to:
cause the UAV booster to launch from a base to a threshold altitude;
decouple the UAV from the attachment mechanism at the threshold altitude; and
responsive to decoupling of the UAV, cause the UAV booster to return to the base.

13. The system of claim 12, wherein the attachment mechanism is included in a plurality of attachment mechanisms.

14. The system of claim 13, wherein each attachment mechanism of the plurality of attachment mechanisms is to couple to a respective UAV of a plurality of UAVs.

15. The system of claim 14, each attachment mechanism of the plurality of attachment mechanisms include a respective movable member, wherein each respective movable member is to actuate from a closed position to an open position when the UAV booster reaches a threshold altitude to expose an opening and permit the UAV to be decoupled, via the exposed opening, from the attachment mechanism.

16. The system of claim 15, wherein a first UAV of the plurality of UAVs is to be selectively decoupled from the UAV booster at first threshold altitude, and wherein a second UAV of the plurality of UAVs is to be selectively decoupled from the UAV booster at a second threshold altitude, wherein the second threshold altitude is different from the first threshold altitude.

17. A non-transitory machine readable medium including instructions executable by a processing resource to:
cause an unmanned aerial vehicle (UAV) booster to launch from a base to reach a threshold altitude;
cause a movable member of the UAV booster to actuate from a closed position to an open position responsive to the UAV booster reaching the threshold altitude; and
cause the movable member of the UAV booster to actuate from the open position to the closed position after a UAV is selectively coupled or decoupled from the UAV booster.

18. The medium of claim 18, further comprising instructions to:
maintain the UAV booster substantially at the threshold altitude for a predetermined period of time; and
responsive to the predetermined period of time elapsing, cause the UAV booster to move to a different altitude.

19. The medium of claim 17, further comprising instructions to cause the UAV booster to return to a base responsive to the predetermined period of time elapsing.

20. The medium of claim 19, further comprising instructions to cause the UAV booster to move to a higher or lower altitude, and selectively decouple the UAV from the UAV booster at the higher or lower altitude.
